(19) United States
(12) Patent Application Publication
(10) Pub. No.: US 2020/0241471 A1
(43) Pub. Date: Jul. 30, 2020

(54) PLASTIC FILM HAVING A UV-CURING ADHESIVE LAYER, FOR THE PROTECTION OF A HOLOGRAM IN A PHOTOPOLYMER FILM COMPOSITE

(71) Applicant: Covestro Deutschland AG, Leverkusen (DE)

(72) Inventors: Serguei KOSTROMINE, Swisttal-Buschhoven (DE); Thomas RÖLLE, Leverkusen (DE); Thomas FÄCKE, Leverkusen (DE); Enrico ORSELLI, Köln (DE)

(21) Appl. No.: 16/611,513

(22) PCT Filed: May 8, 2018
(86) PCT No.: PCT/EP2018/061826

§ 371 Date: Nov. 7, 2019

(30) Foreign Application Priority Data
May 9, 2017 (EP) 17170218.6

(51) Int. Cl. G03H 1/02; G03H 1/00; C09J 7/22; C09J 7/25; B32B 27/36; B32B 27/34; B32B 27/08; B32B 7/12

(52) U.S. Cl. CPC G03H 1/0256; B32B 2310/0837; G03H 1/0248; G03H 1/0272; C09J 7/22; C09J 7/25; B32B 27/365; B32B 27/36; B32B 27/34; B32B 27/08; B32B 7/12; G03H 2001/0264; G03H 2250/35; G03H 2260/12; G03H 2260/33; C09J 2475/00; C09J 2433/00; B32B 2310/0831; G03H 1/0011

(57) ABSTRACT

The invention relates to a sealed holographic medium comprising a layer construction containing a photopolymer layer and a sealing layer, to a process for producing the sealed holographic medium, to a kit of parts, to a layer construction for sealing and to the use thereof.

The invention relates to a sealed holographic medium comprising a layer construction containing a photopolymer layer and a sealing layer, to a process for producing the sealed holographic medium, to a kit of parts, to a layer construction for sealing and to the use thereof.

Photopolymer layers for producing holographic media are known in principle, for example from WO 2011/054797 and WO 2011/067057. Advantages of these holographic media are their high light diffraction efficiency and simplified processing since after holographic irradiation no further chemical and/or thermal development steps are necessary.

The holographic film (Bayfol® HX from Covestro Deutschland AG) consists of a film substrate (A) and a light sensitive photopolymer layer (B). Optical holograms are formed in the layer (B) by local photopolymerization and fixed by areal UV-VIS irradiation. Thus layer (B) forms a no-longer-photosensitive, through-polymerized layer (B′) comprising a previously inscribed hologram. While this hologram is per se very stable over time, its properties can change as a result of mechanical influences and/or on contact with for example organic substances (solvents).

Conceivable methods of protection are lacquering, laminating, adhesive affixing of a protective layer and/or a protective film. For many applications it is necessary that the hologram-containing layer (B′) is protected from the environment not by a lacquer but rather by a protective film and is very largely inseparably joined to the protective film. However, adhesive affixing gives rise to manifold problems associated with liquid adhesive components which on contact with the (B′) layer completely destroy the hologram or on account of severe optical shift render it useless. Also problematic is the provision of an adhesive component which is able to securely adhere to both materials, the hologram-containing layer B′ and the protective film.

A suitable protective film should be laminatable onto the hologram-containing layer (B′) and the adhesive layer on the protective film should be neutral to the hologram, i.e. should cause no deterioration of the intensity of the hologram and no spectral shift of its reflection maximum and should also be securely adherent to both adjacent layers, i.e. to the hologram-containing layer and to the protective film. Furthermore, a good solvent resistance combined with flexibility and elasticity should be ensured after sealing.

Patent applications JP2006023455 (A) and JP2006023456 (A) describe a medium for recording holograms comprising a substrate layer, a photopolymer layer and one or two protective layers. The protective layer is adhesively bonded to the substrate layer, thus embedding the photopolymer layer between the substrate layer and the protective layer without itself being adhesively bonded to the two layers. These protected holographic media are preferably employed in ID cards. For most applications of holographic media where high demands in terms of uniformity and quality apply for the entire surface area of the holographic medium such a layer construction is difficult or even impossible to realize.

Patent application EP 2613318 B1 describes that by suitable selection of the components protective layers can be applied atop an irradiated photopolymer layer. These protective layers are producible by reaction of at least one radiation-curable resin I), an isocyanate-functional resin II) and a photoinitiator system III). The protective layers described in EP 2613318 B1 meet the requirements for a suitable protective layer since they make it possible after application to provide a layer construction comprising a protective layer and an irradiated photopolymer layer which may be securely joined to a very wide variety of adjacent layers such as for example adhesive layers without resulting in a volume change in the photopolymer layer and an accompanying colour change of the hologram.

However, the compositions disclosed in EP 2 613 318 are not satisfactory in every regard. Due to the presence of an isocyanate-functional resin they are comparatively moisture labile and chemically reactive toward isocyanate-reactive components such as for example OH and NH₂ groups. Yet such groups are often present in radiation-curable resins or other assistant substances essential for an industrial formulation. Furthermore, the protective layer is applied atop the photopolymer layer in a “wet” state, i.e. as a solution or dispersion. However in industrial practice it is complex and costly to construct appropriate liquid application plants and provide personnel to monitor the coating process. Lamination processes are therefore preferred but have the disadvantage that they often result in film composites having insufficient adhesion.

It was accordingly an object of the present invention to provide a layer composite of the type mentioned at the outset, wherein the seal is easy to apply and is securely adherent to the hologram-containing layer, the optical properties of the irradiated photopolymer layer are affected very little and permanent resistance to external influences is ensured.

This object is achieved by the sealed holographic medium according to the invention comprising a layer construction B′-C′-D, wherein

B′ is a photopolymer layer containing a hologram, preferably a volume hologram, obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances,

wherein the photopolymer layer B′ is at least partly joined to the layer C′,

C′ is an at least partly actinic-radiation-cured areal layer obtainable from a curable layer C comprising
I) at least one multifunctional acrylate,
II) at least one photoinitiator and
III) optionally assistant and added substances and

D is an areal substrate layer at least partly joined to layer C′,

characterized in that all multifunctional acrylates of the curable layer C are identical to at least one writing monomer of the unirradiated photopolymer layer B.

The photopolymer layer B′ is a photopolymer layer in which a hologram, preferably a volume hologram, has been photoinscribed and this hologram has then been fixed by areal broadband UV/VIS irradiation; the fixing is preferably effected with a light energy dose of 5-10 J/cm².

The advantage of the holographic medium according to the invention is that the photopolymer layer with the photoinscribed hologram is encapsulated by this seal, wherein the component C′ is matched to the layers B′ and D such that good adhesion on B′ and D is ensured and also simultaneously frequency stability/grating stability of the hologram and protection from chemical, physical and mechanical stress is afforded. The use of a crosslinkable acrylate component as adhesive in the layer C for sealing, which is simultaneously also used as a writing monomer in the photopolymer layer B, ensures that there is no negative interaction between the crosslinking component of the adhesive layer and the writing monomers which manifests in a high optical quality of the photoinscribed holograms. In addition the sealing layer achieves a compatibility with further layers and also brings about generally improved handleability of the hologram, for instance protection against dust by inhibiting residual tack or via an antistatic finish to the sealing layer. The sealing layer according to the invention protects the hologram-containing photopolymer layer B′ against physical and chemical influences, such as scratch and solvent damage, coupled with good adhesion of the layers of the construction to one another and flexibility and elasticity of the sealed holographic medium. Furthermore, the “dry” application of the sealing layer atop the unirradiated photopolymer layer avoids provision of complex and costly machines and specially trained personnel as required for example for “wet” application.

The term “areal” in the context of the invention is to be understood as meaning a configuration as a planar area or else as a concavely or convexly vaulted or undulating area. In the context of the invention the hologram-containing photopolymer B′ must therefore have a planar, vaulted or undulating area in order that lamination of the sealing layer is made possible in the hologram region at least.

The term “functional” in the context of the invention in connection with acrylates is to be understood as meaning the number of respective radiation-curable, in particular UV-VIS radiation-curable, reactive groups, preferably in the form of double bonds. The radiation-curable groups are in particular acrylate groups. A “multifunctional acrylate” is accordingly to be understood as meaning a molecule having at least more than one radiation-curable group, in particular acrylate groups, and for example a “trifunctional acrylate” is to be understood as meaning a molecule having three radiation-curable groups, in particular acrylate groups. The radiation-curable groups are in particular free-radically polymerizable groups, such as the acrylate group.

The word “a” in the context of the present invention in connection with countable parameters is to be understood as meaning the number “one” only when this is stated explicitly (for instance by the expression “precisely one”). When reference is made hereinbelow for example to “a polyisocyanate” the word “a” is to be understood as meaning merely the indefinite article and not the number one, this also therefore encompasses an embodiment in which two or more, for example structurally dissimilar, polyisocyanates are present.

In a further embodiment the photopolymer layer B′ is at least partly joined on one side to an areal substrate layer A, wherein the layers are arranged directly atop one another in the sequence A-B′-C′-D. The substrate layer A is preferably a transparent thermoplastic substrate layer or another carrier.

In general all layers A, B, B′, C, C′ and D mentioned herein correspond to the definitions and embodiments given in the description. According to the invention the layer construction C-D, also referred to as layer composite C-D, is as part of a layer construction also described as a sealing layer/curable sealing layer and the layer construction C′-D, also referred to as layer composite C′-D, is as part of a layer construction also described as a cured sealing layer.

In a preferred embodiment the back of the photopolymer layer B′ is at least partly joined to a second at least partly actinic-radiation-cured layer C′, wherein the second layer C′ is on the other side at least partly joined to an areal substrate layer D, wherein the layers are arranged directly atop one another in the sequence D-C′-B′-C′-D. The second layer C′ and the second substrate layer D may be identical or different to the first layer C′ and the first substrate layer D.

In a preferred embodiment the curable layer C further contains at least one thermoplastic mainly linear semicrystalline polyurethane resin.

In a preferred embodiment the multifunctional acrylate of the curable layer C is an at least trifunctional acrylate. In a preferred embodiment the acrylate is selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate. In a particularly preferred embodiment the acrylate is phosphorothioyltris(oxybenzene-4,1-diylcarbamoyloxyethane-2,1-diyl) trisacrylate.

In a further embodiment the layer C contains a UV absorber, preferably in an amount of 0.01% to 10% by weight, more preferably in an amount of 0.1% to 5% by weight, in each case based on the total weight of the layer C.

In a preferred embodiment the substrate layer D is a thermoplastic transparent plastics layer. In another preferred embodiment the substrate layer D is a thermoplastic transparent amorphous plastics layer. In another preferred embodiment the substrate layer D is a thermoplastic transparent low-birefringence plastics layer. In a further preferred embodiment the substrate layer D is an amorphous thermoplastic transparent low-birefringence plastics layer.

In a preferred embodiment the substrate layer D consists of polycarbonate, copolycarbonate, polyethylene terephthalate, cellulose triacetate, polyamide, mixtures or material composites thereof. In another preferred embodiment the substrate layer D consists of polycarbonate, copolycarbonate, cellulose triacetate, polyethylene terephthalate, mixtures or material composites thereof.

In a preferred embodiment the substrate layer D has a layer thickness of 5 μm to 500 μm, preferably 20 μm to 150 μm.

In a further embodiment the sealed holographic medium according to the invention comprises a layer construction B′-C′-D, wherein B′ is a photopolymer layer containing a hologram, preferably a volume hologram, obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances,

wherein the photopolymer layer B′ is at least partly joined to the layer C′,

C′ is an at least partly actinic-radiation-cured areal layer obtainable from a curable layer C comprising
I) at least one multifunctional acrylate,
II) at least one photoinitiator,
III) optionally assistant and added substances and
IV) optionally at least one thermoplastic mainly linear semicrystalline polyurethane resin and

D is an areal substrate layer at least partly joined to layer C′,

characterized in that all multifunctional acrylates of the curable layer C are identical to at least one writing monomer of the unirradiated photopolymer layer B,

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 μm and >20 μm, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

In a further embodiment the sealed holographic medium according to the invention comprises a layer construction B′-C′-D, wherein

B′ is a photopolymer layer containing a hologram, preferably a volume hologram, obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances,

wherein the photopolymer layer B′ is at least partly joined to the layer C′,

C′ is an at least partly actinic-radiation-cured areal layer obtainable from a curable layer C comprising
I) at least one multifunctional acrylate selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate,
II) at least one photoinitiator,
III) optionally assistant and added substances and
IV) optionally at least one thermoplastic mainly linear semicrystalline polyurethane resin and D is an areal substrate layer at least partly joined to layer C′,

characterized in that all multifunctional acrylates of the curable layer C are identical to at least one writing monomer of the unirradiated photopolymer layer B,

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 μm and >20 μm, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

The invention likewise provides a layer construction comprising a curable layer C and an areal substrate layer D at least partly joined to the protective layer C, characterized in that the curable layer C comprises
I) at least one multifunctional acrylate,
II) at least one photoinitiator and
III) optionally assistant and added substances.

The abovementioned layer construction C-D according to the invention corresponds to the sealing layer according to the invention.

In a preferred embodiment the curable layer C further contains at least one thermoplastic mainly linear semicrystalline polyurethane resin.

In a preferred embodiment the multifunctional acrylate of the curable layer C is an at least trifunctional acrylate. In a preferred embodiment the acrylate is selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate. In a particularly preferred embodiment the acrylate is phosphorothioyltris(oxybenzene-4,1-diylcarbamoyloxyethane-2,1-diyl) trisacrylate.

In a further embodiment the layer C contains a UV absorber, preferably in an amount of 0.01% to 10% by weight, more preferably in an amount of 0.1% to 5% by weight, in each case based on the total weight of the layer C.

In a preferred embodiment the substrate layer D is a thermoplastic transparent plastics layer. In another preferred embodiment the substrate layer D is a thermoplastic transparent amorphous plastics layer. In another preferred embodiment the substrate layer D is a thermoplastic transparent low-birefringence plastics layer. In a further preferred embodiment the substrate layer D is an amorphous thermoplastic transparent low-birefringence plastics layer.

In a preferred embodiment the substrate layer D consists of polycarbonate, copolycarbonate, polyethylene terephthalate, cellulose triacetate, polyamide, mixtures or material composites thereof. In another preferred embodiment the substrate layer D consists of polycarbonate, copolycarbonate, cellulose triacetate, polyethylene terephthalate, mixtures or material composites thereof.

In a preferred embodiment the substrate layer D has a layer thickness of 5 μm to 500 μm, preferably 20 μm to 150 μm.

In a further embodiment the layer construction according to the invention comprises a curable layer C and an areal substrate layer D at least partly joined to the layer C, characterized in that the curable layer C comprises
I) at least one multifunctional acrylate,
II) at least one photoinitiator and
III) optionally assistant and added substances.

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 μm and >20 μm, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

In a further embodiment the layer construction according to the invention comprises a curable layer C and an areal substrate layer D at least partly joined to the layer C, characterized in that the curable layer C comprises
I) at least one multifunctional acrylate selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate,
II) at least one photoinitiator and
III) optionally assistant and added substances.

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 μm and >20 μm, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

The layer construction C-D according to the invention may be used in the process according to the invention described below and may be part of the kit of parts according to the invention.

The invention likewise provides a process for producing the sealed holographic medium according to the invention, characterized in that a sealing layer comprising a curable layer C and an areal substrate layer D at least partly joined to the curable layer C is applied atop a photopolymer B′ containing a hologram to afford a layer composite B′-C-D and subsequently the curable layer C is at least partly cured with actinic radiation to afford a layer construction B′-C′-D, wherein C′ is the at least partly cured layer C,

wherein the curable layer C comprises
I) at least one multifunctional acrylate,
II) at least one photoinitiator and
III) optionally assistant and added substances,

wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and

wherein all multifunctional acrylates of the curable layer C are identical to at least one writing monomer of the unirradiated photopolymer layer B.

The process according to the invention has the advantage that the sealing layer comprising a layer C and a substrate layer D is applied “dry”, thus avoiding provision of costly and complex machines and specially trained personnel as is required for example for “wet” application. On account of the very good adhesion of the cured layer C′ both to the substrate layer D and to the photopolymer layer B′ a resistant and difficult-to-separate layer composite is formed in which the hologram is safely encapsulated and sufficiently protected from external influences.

In a preferred embodiment of the process according to the invention the photopolymer layer B′ is disposed on a substrate layer A or another carrier, for example glass or plastic.

In a preferred embodiment of the process according to the invention in a first step a layer composite A-B′ or D-C′-B′ is provided, wherein A is a substrate layer, in a second step the curable layer C is applied atop the substrate layer D to afford a layer composite C-D, in a third step the layer composite C-D is areally joined to the layer composite A-B′ or to the layer composite D-C′-B′, preferably by lamination, to afford a layer composite A-B′-C-D or a layer composite D-C′-B′-C-D respectively and in a fourth step the layer composite A-B′-C-D or the layer composite D-C′-B′-C-D is subjected to actinic radiation to afford a layer composite A-B′-C′-D or a layer composite D-C′-B′-C′-D.

In one embodiment of the process according to the invention an at least partial curing of the layer C of the layer composite A-B′-C-D with actinic radiation is effected over 60 minutes, preferably over 5 minutes, particularly preferably over less than 60 seconds.

In a further embodiment of the process according to the invention this comprises the steps of:
producing a light-sensitive holographic film having the layer construction A-B′, comprising
   preparing a coating composition for producing the photopolymer layer B;
   coating the substrate A with this coating composition to form the layer composite A-B;
   inscribing a hologram into the photopolymer layer B to form the layer composite A-B*, wherein B* is a photopolymer layer comprising an inscribed hologram;
   fixing the hologram in the photopolymer layer B* by areal broadband UV/VIS irradiation of the entire layer construction A-B* with a light energy dose of 5-10 J/cm² to form the layer composite A-B′, wherein B′ is the bleached, through-polymerized and no-longer-photosensitive photopolymer layer B comprising a fixed hologram;
producing a layer composite C-D having a UV-curable layer C, comprising:
   preparing a coating composition for producing the layer C;
   coating the substrate D with this coating composition;
producing a holographic film having the layer construction A-B′-C-D, comprising applying the layer composite C-D atop the layer composite A-B′ followed by areal joining of the two layer composites to one another, preferably by lamination, to form a layer composite A-B′-C-D;
subjecting the layer composite A-B′-C-D to actinic radiation, preferably to UV/VIS radiation with a light energy dose of 5-10 J/cm², to form the layer composite A-B′-C′-D, wherein C′ is the cured protective layer C;

In a preferred embodiment the curable layer C further contains at least one thermoplastic mainly linear semicrystalline polyurethane resin.

In a preferred embodiment the multifunctional acrylate of the curable layer C is an at least trifunctional acrylate. In a preferred embodiment the acrylate is selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate. In a particularly preferred embodiment the acrylate is phosphorothioyltris(oxybenzene-4,1-diylcarbamoyloxyethane-2,1-diyl) trisacrylate.

In a further embodiment the layer C contains a UV absorber, preferably in an amount of 0.01% to 10% by weight, more preferably in an amount of 0.1% to 5% by weight, in each case based on the total weight of the layer C.

In a preferred embodiment the substrate layer D is a thermoplastic transparent plastics layer. In another preferred embodiment the substrate layer D is a thermoplastic transparent amorphous plastics layer. In another preferred embodiment the substrate layer D is a thermoplastic transparent low-birefringence plastics layer. In a further preferred embodiment the substrate layer D is an amorphous thermoplastic transparent low-birefringence plastics layer.

In a preferred embodiment the substrate layer D consists of polycarbonate, copolycarbonate, polyethylene terephthalate, cellulose triacetate, polyamide, mixtures or material composites thereof. In another preferred embodiment the substrate layer D consists of polycarbonate, copolycarbonate, cellulose triacetate, polyethylene terephthalate, mixtures or material composites thereof.

In a preferred embodiment the substrate layer D has a layer thickness of 5 μm to 500 μm, preferably 20 μm to 150 m.

In a further embodiment the process according to the invention for producing the sealed holographic medium according to the invention is characterized in that a sealing layer comprising a curable layer C and an areal substrate layer D at least partly joined to the curable layer C is applied atop a photopolymer B′ containing a hologram to afford a layer composite B′-C-D and subsequently the curable layer C is at least partly cured with actinic radiation to afford a layer construction B′-C′-D,

wherein C′ is the at least partly cured layer C,

wherein the curable layer C comprises
I) at least one multifunctional acrylate,
II) at least one photoinitiator and
III) optionally assistant and added substances,

wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and

wherein all multifunctional acrylates of the curable layer C are identical to at least one writing monomer of the unirradiated photopolymer layer B,

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 μm and >20 μm, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

In a further embodiment the process according to the invention for producing the sealed holographic medium according to the invention is characterized in that a sealing layer comprising a curable layer C and an areal substrate layer D at least partly joined to the curable layer C is applied atop a photopolymer B′ containing a hologram to afford a layer composite B′-C-D and subsequently the curable layer C is at least partly cured with actinic radiation to afford a layer construction B′-C′-D,

wherein C′ is the at least partly cured layer C,

wherein the curable layer C comprises
I) at least one multifunctional acrylate selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate,
II) at least one photoinitiator and
III) optionally assistant and added substances,

wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and

wherein all multifunctional acrylates of the curable layer C are identical to at least one writing monomer of the unirradiated photopolymer layer B,

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 μm and >20 μm, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

The invention likewise provides a sealed holographic medium comprising a layer construction A-B′-C′-D, a sealed holographic medium comprising a layer construction B′-C′-D, a sealed holographic medium comprising a layer construction B′-C′-D and a sealed holographic medium comprising a layer construction D-C′-B′-C′-D obtainable from the above-described process according to the invention.

The sealed holographic medium according to the invention may have at least one hologram photoinscribed in it.

The spectral shift of the transmission spectrum is defined as the difference (Δλ) between the wavelength of the inscribing laser (λ_{w}) and the spectral peak of the inscribed hologram (λₚₑₐₖ) (ISO standard 17901-1:2015(E)):

Δλ=λₚₑₐₖ−λ_{w} (3)

It is preferable when A of the inscribed hologram in the inventive layer construction A-B′-C′-D is +/−10 nm, more preferably +/−5 nm, particularly preferably +/−3 nm.

The invention likewise provides a kit of parts containing at least one areal photopolymer B′ containing a hologram, preferably a volume hologram, and a sealing layer comprising a curable layer C and an areal substrate layer D at least partly joined to the curable layer C, characterized in that the curable layer C comprises
I) at least one multifunctional acrylate,
II) at least one photoinitiator and
III) optionally assistant and added substances,

wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and

wherein all multifunctional acrylates of the curable layer C are identical to at least one writing monomer of the unirradiated photopolymer layer B.

In a preferred embodiment of the kit of parts according to the invention the photopolymer layer B′ is disposed on a substrate layer A, wherein the photopolymer layer B′ is on one side at least partly joined to the substrate layer A.

In another preferred embodiment of the kit of parts according to the invention the photopolymer layer B′ is in the form of a layer composite D-C-B′, wherein the photopolymer layer B′ is on one side at least partly joined to the uncured substrate layer C. The layer composite D-C-B′ may be produced as described above.

In another preferred embodiment of the kit of parts according to the invention the photopolymer layer B′ is in the form of a layer composite D-C′-B′, wherein the photopolymer layer B′ is on one side at least partly joined to the uncured substrate layer C′. The layer composite D-C′-B′ may be produced as described above.

In a preferred embodiment the curable layer C further contains at least one thermoplastic mainly linear semicrystalline polyurethane resin.

In a preferred embodiment the multifunctional acrylate of the curable layer C is an at least trifunctional acrylate. In a preferred embodiment the acrylate is selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate. In a particularly preferred embodiment the acrylate is phosphorothioyltris(oxybenzene-4,1-diylcarbamoyloxyethane-2,1-diyl) trisacrylate.

In a further embodiment the layer C contains a UV absorber, preferably in an amount of 0.01% to 10% by weight, more preferably in an amount of 0.1% to 5% by weight, in each case based on the total weight of the layer C.

In a preferred embodiment the substrate layer D is a thermoplastic transparent plastics layer. In another preferred embodiment the substrate layer D is a thermoplastic transparent amorphous plastics layer. In another preferred embodiment the substrate layer D is a thermoplastic transparent low-birefringence plastics layer. In a further preferred embodiment the substrate layer D is an amorphous thermoplastic transparent low-birefringence plastics layer.

In a preferred embodiment the substrate layer D consists of polycarbonate, copolycarbonate, polyethylene terephthalate, cellulose triacetate, polyamide, mixtures or material composites thereof. In another preferred embodiment the substrate layer D consists of polycarbonate, copolycarbonate, cellulose triacetate, polyethylene terephthalate, mixtures or material composites thereof.

In a preferred embodiment the substrate layer D has a layer thickness of 5 μm to 500 μm, preferably 20 μm to 150 μm.

In a further embodiment the kit of parts according to the invention comprises at least one areal photopolymer B′ containing a hologram, preferably a volume hologram, and a sealing layer comprising a curable layer C and an areal substrate layer D at least partly joined to the curable layer C, characterized in that the curable layer C comprises
I) at least one multifunctional acrylate,
II) at least one photoinitiator and
III) optionally assistant and added substances,

wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and

wherein all multifunctional acrylates of the curable layer C are identical to at least one writing monomer of the unirradiated photopolymer layer B.

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 m and >20 m, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

In a further embodiment the kit of parts according to the invention comprises at least one areal photopolymer B′ containing a hologram, preferably a volume hologram, and a sealing layer comprising a curable layer C and an areal substrate layer D at least partly joined to the curable layer C, characterized in that the curable layer C comprises
I) at least one multifunctional acrylate selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate,
II) at least one photoinitiator and
III) optionally assistant and added substances,

wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and

wherein all multifunctional acrylates of the curable layer C are identical to at least one writing monomer of the unirradiated photopolymer layer B,

wherein D is a thermoplastic transparent plastics layer of polycarbonate or copolycarbonate, preferably of polycarbonate, more preferably of polycarbonate having an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging or

wherein D is a thermoplastic transparent plastics layer of cellulose triacetate (CTA or TAC), in particular a plastics layer of cellulose triacetate having a layer thickness of <200 μm, more preferably <100 μm and >20 μm, yet more preferably <65 μm and >20 μm, or

wherein D is a thermoplastic transparent plastics layer of polyester, in particular a plastics layer of polyethylene terephthalate (PET) having a layer thickness of <200 μm, more preferably <100 μm and >20 μm, by preference <45 μm and >20 μm, more preferably a plastics layer of polyethylene terephthalate (PET) whose adhesion properties have been reduced by surface modification.

Substrate Layer A

The substrate layer A is preferably a thermoplastic substrate layer/substrate film or another carrier, for example glass, plastic, metal or wood. Materials or material composites of the thermoplastic substrate layer A are based on polycarbonate (PC), polyethylene terephthalate (PET), amorphous polyesters, polybutylene terephthalate, polyethylene, polypropylene, cellulose acetate, cellulose hydrate, cellulose nitrate, cycloolefin polymers, polystyrene, hydrogenated polystyrene, polyepoxides, polysulfone, thermoplastic polyurethane (TPU), cellulose triacetate (CTA), polyamide (PA), polymethyl methacrylate (PMMA), polyvinyl chloride, polyvinyl acetate, polyvinyl butyral or polydicyclopentadiene or mixtures thereof. They are particularly preferably based on PC, PET, PA, PMMA and CTA. Material composites may be film laminates or coextrudates. Preferred material composites are duplex and triplex films constructed according to one of the schemes A/B, A/B/A or A/B/C. Particularly preferred are PC/PMMA, PC/PA, PC/PET, PET/PC/PET and PC/TPU. It is preferable when substrate layer A is transparent in the spectral region of 400-800 nm.

Photopolymer Layer B

The photopolymer layer B′ is generated by inscribing a hologram into the unirradiated photopolymer layer B followed by optical fixing of the hologram preferably by areal broadband UV/VIS irradiation of the photopolymer layer comprising the inscribed hologram with a light energy dose of 5-10 J/cm². During the fixing, residues of writing monomers that were not involved in the local formation of the hologram are through-polymerized in the entire photopolymer layer. The dyes used as sensitizers are likewise photochemically destroyed. The strong technological discoloration of the photopolymer layer B caused by dyes disappears entirely. The photopolymer layer B is bleached by the fixing and is converted into a no-longer-photoactive, dye-free stable photopolymer layer B′ comprising an inscribed hologram.

In the photopolymer layer one or more holograms may be/may have been photoinscribed at the same location or next to one another. If photoinscribing is performed at the same location different image contents may be photoinscribed. It is likewise possible to photoinscribe different aspects of an object with slightly varying reconstruction angles to form stereograms. It is likewise possible to photoinscribe hidden holograms and microtexts. It is likewise possible in the case of transmission holograms to photoinscribe several light guiding functions and/or light guiding functions for different spectral ranges.

The photopolymer layer B′ preferably comprises crosslinked matrix polymers, in particular three-dimensionally crosslinked matrix polymers, wherein the matrix polymers are preferably polyurethanes.

The photopolymer layer B comprises matrix polymers, writing monomers and photoinitiators. Employable matrix polymers are amorphous thermoplastics, for example polyacrylates, polymethyl methacrylates or copolymers of methyl methacrylate, methacrylic acid or other alkyl acrylates and alkyl methacrylates, and also acrylic acid, for example polybutyl acrylate, and also polyvinyl acetate and polyvinyl butyrate, the partially hydrolysed derivatives thereof, such as polyvinyl alcohols, and copolymers with ethylene and/or further (meth)acrylates, gelatins, cellulose esters and cellulose ethers such as methyl cellulose, cellulose acetobutyrate, silicones, for example polydimethylsilicone, polyurethanes, polybutadienes and polyisoprenes, and also polyethylene oxides, epoxy resins, in particular aliphatic epoxy resins, polyamides, polycarbonates and the systems in U.S. Pat. No. 4,994,347A and cited therein.

Epoxy resins may be cationically intracrosslinked. In addition, it is also possible to use acids/anhydrides, amines, hydroxyalkyl amides and thiols as crosslinkers. Silicones can be crosslinked either as one-component systems through condensation in the presence of water (and optionally under Brønsted acid catalysis) or as two-component systems by addition of silicic ester or organotin compounds. Hydrosilylation in vinyl-silane systems is also possible.

Unsaturated compounds, for example acryloyl-functional polymers or unsaturated esters, can be crosslinked with amines or thiols. Cationic vinyl ether polymerization is also possible.

However, it is especially preferable when the matrix polymers are crosslinked, preferably three-dimensionally crosslinked, and very particularly preferably are three-dimensionally crosslinked polyurethanes.

Polyurethane matrix polymers are obtainable in particular by reaction of at least one polyisocyanate component a) with at least one isocyanate-reactive component b).

The polyisocyanate component a) comprises at least one organic compound having at least two NCO groups. These organic compounds may in particular be monomeric di- and triisocyanates, polyisocyanates and/or NCO-functional prepolymers. The polyisocyanate component a) may also contain or consist of mixtures of monomeric di- and triisocyanates, polyisocyanates and/or NCO-functional prepolymers.

Employable monomeric di- and triisocyanates include all of the compounds or mixtures thereof well known per se to the person skilled in the art. These compounds may have aromatic, araliphatic, aliphatic or cycloaliphatic structures. In minor amounts the monomeric di- and triisocyanates may also comprise monoisocyanates, i.e. organic compounds having one NCO group.

Examples of suitable monomeric di- and triisocyanates are butane 1,4-diisocyanate, pentane 1,5-diisocyanate, hexane 1,6-diisocyanate (hexamethylene diisocyanate, HDI), 2,2,4-trimethylhexamethylene diisocyanate and/or 2,4,4-trimethylhexamethylene diisocyanate (TMDI), isophorone diisocyanate (IPDI), 1,8-diisocyanato-4-(isocyanatomethyl)octane, bis(4,4′-isocyanatocyclohexyl)methane and/or bis(2′,4-isocyanatocyclohexyl)methane and/or mixtures thereof with any isomer content, cyclohexane 1,4-diisocyanate, the isomeric bis(isocyanatomethyl)cyclohexanes, 2,4- and/or 2,6-diisocyanato-1-methylcyclohexane, (hexahydrotolylene 2,4- and/or 2,6-diisocyanate, H6-TDI), phenylene 1,4-diisocyanate, tolylene 2,4- and/or 2,6-diisocyanate (TDI), naphthylene 1,5-diisocyanate (NDI), diphenylmethane 2,4′- and/or 4,4′-diisocyanate (MDI), 1,3-bis(isocyanatomethyl)benzene (XDI) and/or the analogous 1,4 isomer, or any desired mixtures of the aforementioned compounds.

Suitable polyisocyanates are compounds which have urethane, urea, carbodiimide, acylurea, amide, isocyanurate, allophanate, biuret, oxadiazinetrione, uretdione and/or iminooxadiazinedione structures and are obtainable from the aforementioned di- or triisocyanates.

It is particularly preferable when the polyisocyanates are oligomerized aliphatic and/or cycloaliphatic di- or triisocyanates, the abovementioned aliphatic and/or cycloaliphatic di- or triisocyanates in particular being employable.

Very particular preference is given to polyisocyanates having isocyanurate, uretdione and/or iminooxadiazinedione structures and also to biurets based on HDI or mixtures thereof.

Suitable prepolymers contain urethane and/or urea groups, and optionally further structures formed through modification of NCO groups as recited above. Such prepolymers are obtainable for example by reaction of the abovementioned monomeric di- and triisocyanates and/or polyisocyanates al) with isocyanate-reactive compounds b1).

Employable isocyanate-reactive compounds b1) include alcohols or amino or mercapto compounds, preferably alcohols. These may in particular be polyols. Very particularly preferably employable as isocyanate-reactive compound b1) are polyester polyols, polyether polyols, polycarbonate polyols, poly(meth)acrylate polyols and/or polyurethane polyols.

Suitable polyester polyols are, for example, linear polyester diols or branched polyester polyols which can be obtained in a known manner by reacting aliphatic, cycloaliphatic or aromatic di- or polycarboxylic acids or the anhydrides thereof with polyhydric alcohols of OH functionality ≥2. Examples of suitable di- or polycarboxylic acids are polybasic carboxylic acids such as succinic acid, adipic acid, suberic acid, sebacic acid, decanedicarboxylic acid, phthalic acid, terephthalic acid, isophthalic acid, tetrahydrophthalic acid or trimellitic acid, and acid anhydrides such as phthalic anhydride, trimellitic anhydride or succinic anhydride, or any desired mixtures thereof. The polyester polyols may also be based on natural raw materials such as castor oil. It is likewise possible that the polyester polyols are based on homo- or copolymers of lactones which are preferably obtainable by addition of lactones or lactone mixtures such as butyrolactone, ε-caprolactone and/or methyl-ε-caprolactone onto hydroxy-functional compounds such as polyhydric alcohols of OH functionality ≥2, for example of the kind recited below.

Examples of suitable alcohols are all polyhydric alcohols, for example the C₂-C₁₂ diols, the isomeric cyclohexanediols, glycerol or any desired mixtures thereof with one another.

Suitable polycarbonate polyols are obtainable in a manner known per se by reacting organic carbonates or phosgene with diols or diol mixtures.

Suitable organic carbonates are dimethyl carbonate, diethyl carbonate and diphenyl carbonate.

Suitable diols or mixtures comprise the polyhydric alcohols of OH functionality >2 mentioned per se in the context of the polyester segments, preferably butane-1,4-diol, hexane-1,6-diol and/or 3-methylpentanediol. It is also possible to convert polyester polyols to polycarbonate polyols.

Suitable polyether polyols are polyaddition products, optionally of blockwise construction, of cyclic ethers onto OH- or NH-functional starter molecules.

Suitable cyclic ethers are, for example, styrene oxides, ethylene oxide, propylene oxide, tetrahydrofuran, butylene oxide, epichlorohydrin and any desired mixtures thereof.

Starters used may be the polyhydric alcohols of OH functionality ≥2 mentioned per se in the context of the polyester polyols, and also primary or secondary amines and amino alcohols.

Preferred polyether polyols are those of the aforementioned type based exclusively on propylene oxide, or random or block copolymers based on propylene oxide with further 1-alkylene oxides.

Particular preference is given to propylene oxide homopolymers and random or block copolymers having oxyethylene, oxypropylene and/or oxybutylene units, where the proportion of the oxypropylene units based on the total amount of all oxyethylene, oxypropylene and oxybutylene units makes up at least 20% by weight, preferably at least 45% by weight. Oxypropylene and oxybutylene here include all respective linear and branched C₃ and C₄ isomers.

In addition, suitable constituents of the polyol component b1), as polyfunctional isocyanate-reactive compounds, are also aliphatic, araliphatic or cycloaliphatic di-, tri- or polyfunctional alcohols of low molecular weight, i.e. having molecular weights of ≤500 g/mol, and having short chains, i.e. containing 2 to 20 carbon atoms.

These may be, for example, in addition to the abovementioned compounds, neopentyl glycol, 2-ethyl-2-butylpropanediol, trimethylpentanediol, positionally isomeric diethyloctanediols, cyclohexanediol, cyclohexane-1,4-dimethanol, hexane-1,6-diol, cyclohexane-1,2- and -1,4-diol, hydrogenated bisphenol A, 2,2-bis(4-hydroxycyclohexyl)propane or 2,2-dimethyl-3-hydroxypropionic acid, 2,2-dimethyl-3-hydroxypropyl esters. Examples of suitable triols are trimethylolethane, trimethylolpropane or glycerol. Suitable higher-functionality alcohols are di(trimethylolpropane), pentaerythritol, dipentaerythritol or sorbitol.

It is particularly preferred when the polyol component is a difunctional polyether or polyester or a polyether-polyester block copolyester or a polyether-polyester block copolymer with primary OH functions.

It is likewise possible to use amines as isocyanate-reactive compounds b1). Examples of suitable amines are ethylenediamine, propylenediamine, diaminocyclohexane, 4,4′-dicyclohexylmethanediamine, isophoronediamine (IPDA), difunctional polyamines, for example the Jeffamines®, amine-terminated polymers, in particular having number-average molar masses <10 000 g/mol. Mixtures of the aforementioned amines may likewise be used.

It is likewise possible to use amino alcohols as isocyanate-reactive compounds b1). Examples of suitable amino alcohols are the isomeric aminoethanols, the isomeric aminopropanols, the isomeric aminobutanols and the isomeric aminohexanols or any desired mixtures thereof.

All the aforementioned isocyanate-reactive compounds b1) can be mixed with one another as desired.

It is also preferable when the isocyanate-reactive compounds b1) have a number-average molar mass of ≥200 and ≤10 000 g/mol, more preferably ≥500 and ≤8,000 g/mol and very particularly preferably ≥800 and ≤5,000 g/mol. The OH functionality of the polyols is preferably 1.5 to 6.0, particularly preferably 1.8 to 4.0.

The prepolymers of the polyisocyanate component a) may in particular have a residual content of free monomeric di- and triisocyanates of <1% by weight, particularly preferably <0.5% by weight and very particularly preferably <0.3% by weight.

It may also be possible for the polyisocyanate component a) to contain, in full or in part, an organic compound wherein the NCO groups have been fully or partly reacted with blocking agents known from coating technology. Examples of blocking agents are alcohols, lactams, oximes, malonic esters, pyrazoles, and amines, for example butanone oxime, diisopropylamine, diethyl malonate, ethyl acetoacetate, 3,5-dimethylpyrazole, ε-caprolactam, or mixtures thereof.

It is particularly preferable when the polyisocyanate component a) comprises compounds having aliphatically bonded NCO groups, where aliphatically bonded NCO groups are understood to mean those groups bonded to a primary carbon atom. The isocyanate-reactive component b) preferably comprises at least one organic compound having on average least 1.5 and preferably 2 to 3 isocyanate-reactive groups. In the context of the present invention, isocyanate-reactive groups are preferably considered to be hydroxyl, amino or mercapto groups.

The isocyanate-reactive component may particular comprise compounds having a number average of at least 1.5 and preferably 2 to 3 isocyanate-reactive groups.

Suitable polyfunctional isocyanate-reactive compounds of component b) are for example the above-described compounds b1).

Photoinitiators suitable according to the invention are typically compounds which are activatable by actinic radiation and can initiate polymerization of the writing monomers. Among the photoinitiators a distinction may be made between unimolecular (type I) and bimolecular (type II) initiators. In addition, they are distinguished by their chemical nature in photoinitiators for free-radical, anionic, cationic or mixed types of polymerization.

Type I photoinitiators (Norrish type 1) for free-radical photopolymerization on irradiation form free radicals through unimolecular bond scission. Examples of type I photoinitiators are triazines, oximes, benzoin ethers, benzil ketals, bisimidazoles, aroylphosphine oxides, sulfonium salts and iodonium salts.

Type II photoinitiators (Norrish type II) for free-radical polymerization consist of a dye sensitizer and a coinitiator, and undergo a bimolecular reaction on irradiation with light attuned to the dye.

The dye at first absorbs a photon and transmits energy to the coinitiator from an excited state. The latter releases the polymerization-initiating free radicals through electron or proton transfer or direct hydrogen abstraction.

In the context of the present invention, preference is given to using type II photoinitiators.

The dye and the coinitiator of the type II photoinitiators may either be directly mixed conjointly with the further components of the photopolymer or alternatively be singly premixed with individual components. Especially when the photopolymer is to contain polyurethane matrix polymers, the dye may be premixed with the isocyanate-reactive component and the coinitiator with the isocyanate component. However, it is likewise also possible to mix the coinitiator with the isocyanate-reactive component and the dye with the isocyanate component beforehand.

Such photoinitiator systems are described in principle in EP 0 223 587 A and preferably consist of a mixture of one or more dyes with ammonium alkylarylborate(s).

Suitable dyes which, together with an ammonium alkylarylborate, form a type 11 photoinitiator are the cationic dyes described in WO 2012062655 in combination with the anions likewise described therein.

Suitable ammonium alkylarylborates are for example (Cunningham et al., RadTech'98 North America UV/EB Conference Proceedings, Chicago, Apr. 19-22, 1998): tetrabutylammonium triphenylhexylborate, tetrabutylammonium triphenylbutylborate, tetrabutylammonium trinaphthylhexylborate, tetrabutylammonium tris(4-tert-butyl)phenylbutylborate, tetrabutylammonium tris(3-fluorophenyl)hexylborate ([191726-69-9], CGI 7460, product from BASF SE, Basle, Switzerland), 1-methyl-3-octylimidazolium dipentyldiphenylborate and tetrabutylammonium tris(3-chloro-4-methylphenyl)hexylborate ([1147315-11-4], CGI 909, product from BASF SE, Basle, Switzerland).

It may be advantageous to use mixtures of these photoinitiators. According to the radiation source used, the type and concentration of photoinitiator has to be adjusted in the manner known to those skilled in the art. Further details are described, for example, in P. K. T. Oldring (Ed.), Chemistry & Technology of UV & EB Formulations For Coatings, Inks & Paints, Vol. 3, 1991, SITA Technology, London, p. 61-328.

It is very particularly preferable when the photoinitiator comprises a combination of dyes whose absorption spectra at least partly cover the spectral range from 400 to 800 nm with at least one coinitiator attuned to the dyes.

It is also preferable when at least one photoinitiator suitable for a laser light colour selected from blue, green and red is present in the photopolymer formulation.

It is furthermore preferable when the photopolymer formulation contains a suitable photoinitiator for each of at least two laser light colours selected from blue, green and red.

Finally, it is very particularly preferable when the photopolymer formulation contains a suitable photoinitiator for each of the laser light colours blue, green and red.

A further preferred embodiment provides that the writing monomers comprise a mono- and/or a multifunctional (meth)acrylate writing monomer. The writing monomers may very particularly preferably further comprise at least one mono- and/or one multifunctional urethane (meth)acrylate.

Suitable acrylate writing monomers are in particular compounds of general formula (I)

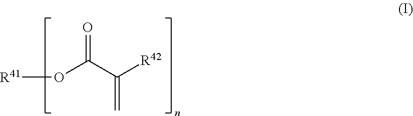

where n≥1 and n≤4 and R⁴¹ is a linear, branched, cyclic or heterocyclic unsubstituted or else optionally heteroatom-substituted organic radical and/or R⁴² is hydrogen, a linear, branched, cyclic or heterocyclic unsubstituted or else optionally heteroatom-substituted organic radical. It is particularly preferable when R⁴² is hydrogen or methyl and/or R⁴¹ is a linear, branched, cyclic or heterocyclic unsubstituted or else optionally heteroatom-substituted organic radical.

Acrylates and methacrylates refer in the present context, respectively, to esters of acrylic acid and methacrylic acid. Examples of acrylates and methacrylates usable with preference are phenyl acrylate, phenyl methacrylate, phenoxyethyl acrylate, phenoxyethyl methacrylate, phenoxyethoxyethyl acrylate, phenoxyethoxyethyl methacrylate, phenylthioethyl acrylate, phenylthioethyl methacrylate, 2-naphthyl acrylate, 2-naphthyl methacrylate, 1,4-bis(2-thionaphthyl)-2-butyl acrylate, 1,4-bis(2-thionaphthyl)-2-butyl methacrylate, bisphenol A diacrylate, bisphenol A dimethacrylate, and the ethoxylated analogue compounds thereof, N-carbazolyl acrylates.

Urethane acrylates are understood in the present context to mean compounds having at least one acrylic ester group and at least one urethane bond. Such compounds can be obtained, for example, by reacting a hydroxy-functional acrylate or methacrylate with an isocyanate-functional compound.

Examples of isocyanate-functional compounds usable for this purpose are monoisocyanates, and the monomeric diisocyanates, triisocyanates and/or polyisocyanates mentioned under a). Examples of suitable monoisocyanates are phenyl isocyanate, the isomeric methylthiophenyl isocyanates. Di-, tri- or polyisocyanates are mentioned above as are triphenylmethane 4,4′,4″-triisocyanate and tris(p-isocyanatophenyl) thiophosphate or derivatives thereof having a urethane, urea, carbodiimide, acylurea, isocyanurate, allophanate, biuret, oxadiazinetrione, uretdione or iminooxadiazinedione structure and mixtures thereof. Preference is given here to aromatic di-, tri- or polyisocyanates.

Contemplated hydroxy-functional acrylates or methacrylates for the production of urethane acrylates include, for example, compounds such as 2-hydroxyethyl (meth)acrylate, polyethylene oxide mono(meth)acrylates, polypropylene oxide mono(meth)acrylates, polyalkylene oxide mono(meth)acrylates, poly(s-caprolactone) mono(meth)acrylates, for example Tone® M100 (Dow, Schwalbach, DE), 2-hydroxypropyl (meth)acrylate, 4-hydroxybutyl (meth)acrylate, 3-hydroxy-2,2-dimethylpropyl (meth)acrylate, hydroxypropyl (meth)acrylate, 2-hydroxy-3-phenoxypropyl acrylate, the hydroxy-functional mono-, di- or tetraacrylates of polyhydric alcohols such as trimethylolpropane, glycerol, pentaerythritol, dipentaerythritol, ethoxylated, propoxylated or alkoxylated trimethylolpropane, glycerol, pentaerythritol, dipentaerythritol or the technical grade mixtures thereof. Preference is given to 2-hydroxyethyl acrylate, hydroxypropyl acrylate, 4-hydroxybutyl acrylate and poly(ε-caprolactone) mono(meth)acrylate.

It is likewise possible to use the known-per-se hydroxyl-containing epoxy (meth)acrylates having OH contents of 20 to 300 mg KOH/g or hydroxyl-containing polyurethane (meth)acrylates having OH contents of 20 to 300 mg KOH/g or acrylated polyacrylates having OH contents of 20 to 300 mg KOH/g and mixtures of these with one another, and mixtures with hydroxyl-containing unsaturated polyesters and mixtures with polyester (meth)acrylates or mixtures of hydroxyl-containing unsaturated polyesters with polyester (meth)acrylates.

Preference is given in particular to urethane acrylates obtainable from the reaction of tris(p-isocyanatophenyl) thiophosphate and/or m-methylthiophenyl isocyanate with alcohol-functional acrylates such as hydroxyethyl (meth)acrylate, hydroxypropyl (meth)acrylate and/or hydroxybutyl (meth)acrylate.

It is likewise possible that the writing monomer comprises further unsaturated compounds such as β,β-unsaturated carboxylic acid derivatives, for example maleates, fumarates, maleimides, acrylamides, and also vinyl ethers, propenyl ethers, allyl ethers and compounds containing dicyclopentadienyl units, and also olefinically unsaturated compounds, for example styrene, α-methylstyrene, vinyltoluene and/or olefins.

In a further preferred embodiment, it is provided that the photopolymer formulation additionally contains monomeric urethanes as additives, in which case the urethanes may especially be substituted by at least one fluorine atom.

The urethanes may preferably have the general formula (II)

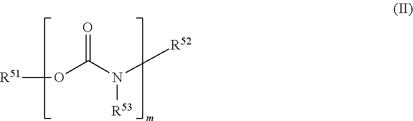

in which m≥1 and m≤8 and R⁵¹, R⁵² and R⁵³ are linear, branched, cyclic or heterocyclic unsubstituted or else optionally heteroatom-substituted organic radicals and/or R⁵², R⁵³ are independently of one another hydrogen, wherein preferably at least one of the radicals R⁵¹, R⁵², R⁵³ is substituted by at least one fluorine atom and particularly preferably R⁵¹ is an organic radical having at least one fluorine atom. It is particularly preferable when R⁵² is a linear, branched, cyclic or heterocyclic organic radical which is unsubstituted or else optionally substituted with heteroatoms, for example fluorine.

In a further preferred embodiment of the invention, the photopolymer contains 10% to 89.999% by weight, preferably 20% to 70% by weight, of matrix polymers, 3% to 60% by weight, preferably 10% to 50% by weight, of writing monomers, 0.001% to 5% by weight, preferably 0.5% to 3% by weight, of photoinitiators and optionally 0% to 4% by weight, preferably 0% to 2% by weight, of catalysts, 0% to 5% by weight, preferably 0.001% to 1% by weight, of stabilizers, 0% to 40% by weight, preferably 10% to 30% by weight, of monomeric fluorourethanes and 0% to 5% by weight, preferably 0.1% to 5% by weight, of further additives, wherein the sum of all constituents is 100% by weight.

Particular preference is given to using photopolymers comprising 20% to 70% by weight of matrix polymers, 20% to 50% by weight of writing monomers, 0.001% to 5% by weight of photoinitiators, 0% to 2% by weight of catalysts, 0.001% to 1% by weight of free-radical stabilizers, optionally 10% to 30% by weight of fluorourethanes and optionally 0.1% to 5% by weight of further additives.

Employable catalysts include urethanization catalysts, for example organic or inorganic derivatives of bismuth, of tin, of zinc or of iron (see also the compounds specified in US 2012/062658). Particularly preferred catalysts are butyltin tris(2-ethylhexanoate), iron(III) trisacetylacetonate, bismuth(III) tris(2-ethylhexanoate) and tin(II) bis(2-ethylhexanoate). In addition, it is also possible to use sterically hindered amines as catalysts.

Employable stabilizers include free-radical inhibitors such as HALS amines, N-alkyl HALS, N-alkoxy HALS and N-alkoxyethyl HALS compounds, and also antioxidants and/or UV absorbers.

Employable further additives include flow control agents and/or antistats and/or thixotropic agents and/or thickeners and/or biocides.

Layer C

Before curing with actinic radiation the layer C comprises at least one multifunctional acrylate, optionally at least one physically drying polymeric resin, at least one photoinitiator and optionally assistant and added substances. It is preferable when the layer C additionally comprises a UV absorber in an amount of 0.1% to 10% by weight.

The at least one multifunctional acrylate is preferably selected from the group consisting of phosphorothioyltris(oxybenzene-4,1-diylcarbamoyloxyethane-2,1-diyl) trisacrylate, phosphoroxytris(oxybenzene-4,1-diylcarbamoyloxyethane-2,1-diyl) trisacrylate, 2-[[4-[bis[4-(2-prop-2-enoyloxyethoxycarbonylamino)phenyl]methyl]phenyl]carbamoyloxy]ethyl prop-2-enoate, preferably an at least trifunctional acrylate, more preferably phosphorothioyltris(oxybenzene-4,1-diylcarbamoyloxyethane-2,1-diyl) trisacrylate, phosphoroxytris(oxybenzene-4,1-diylcarbamoyloxyethan-2,1-diyl) trisacrylate and/or 2-[[4-[bis[4-(2-prop-2-enoyloxyethoxycarbonylamino)phenyl]methyl]phenyl]carbamoyloxy]ethyl prop-2-enoate. Particular preference is given to phosphorothioyltris(oxybenzene-4,1-diylcarbamoyloxyethan-2,1-diyl) trisacrylate.

The optionally used physically drying resins for the layer C are thermoplastic mainly linear semicrystalline polyurethanes (see for example Gtinter Oertel (editor): Kunsistoff-Handbuch—Bd 7 Polyurethane. 3rd Edition. Carl Hanser Verlag, 1993). Preference is given to the Desmocoll® and Desmomelt@ polyurethanes from Covestro Deutschland AG which have been specially developed as thermoactivating adhesives. Further examples for suitable thermoplastic mainly linear semicrystalline polyurethanes for the layer C are described in DE 3729068 A1, DE 3702394 A1 and US 20050112971 A1, the disclosure of which in this regard is hereby incorporated herein by reference.

The employed photoinitiators are typically compounds which are activatable by actinic radiation and can initiate polymerization of the corresponding groups.

Among the photoinitiators a distinction may be made between unimolecular (type I) and bimolecular (type II) initiators for initiating free-radical polymerization; there is extensive prior art concerning this.

Type I photoinitiators (Norrish type I) for free-radical photopolymerization on irradiation form free radicals through unimolecular bond scission.

Examples of type I photoinitiators are triazines, for example tris(trichloromethyl)triazine, oximes, benzoin ethers, benzil ketals, alpha-alpha-dialkoxyacetophenone, phenylglyoxylic esters, bisimidazoles, aroyl phosphinoxides, for example 2,4,6-trimethylbenzoyldiphenylphosphinoxide, sulfonium and iodonium salts.

Type II photoinitiators (Norrish type II) for free-radical polymerization on irradiation undergo a bimolecular reaction, wherein the photoinitiator in the excited state reacts with a second molecule, the coinitiator, and by electron or proton transfer or direct hydrogen abstraction forms the polymerization-initiating free radicals.

Examples of type II photoinitiators are quinones, for example camphorquinone, aromatic keto compounds, for example benzophenones in combination with tertiary amines, alkyl benzophenones, halogenated benzophenones, 4,4′-bis(dimethylamino)benzophenone (Michlers ketone), anthrone, methyl-p-(dimethylamino) benzoate, thioxanthone, ketocoumarins, alpha-aminoalkylphenone, alpha-hydroxyalkylphenone and cationic dyes, for example methylene blue, in combination with tertiary amines.

For the UV and shortwave visible range type I and type II photoinitiators are employed and for the longer wave visible light range predominantly type II photoinitiators are employed.

Preference is given to 1-hydroxycyclohexyl phenyl ketone (e.g. Irgacure 184 from BASF SE), 2-hydroxy-2-methyl-1-phenyl-1-propanone (e.g. Irgacure® 1173 from BASF SE), 2-hydroxy-1-4-[4-(2-hydroxy-2-methyl-propionyl)-benzyl]-phenyl)-2-methylpropan-1-one (e.g. Irgacure® 127 from BASF SE), 2-hydroxy-1-[4-(2-hydroxyethoxy)phenyl]-2-methyl-1-propanone (e.g. Irgacure® 2959 from BASF SE); 2,4,6-trimethylbenzoyldiphenylphosphine oxides (e.g. Lucirin® TPO from BASF SE); 2,4,6-trimethylbenzoyldiphenyl phosphinates (e.g. Lucirin® TPO-L from BASF SE), bis(2,4,6-trimethylbenzoyl)phenylphosphine oxide (Lucirin® 819); [1-(4-phenylsulfanylbenzoyl)heptylideneamino] benzoate (e.g. Irgacure® OXE 01 from BASF SE); [1-[9-ethyl-6-(2-methylbenzoyl)carbazol-3-yl]ethylideneamino] acetate (e.g. Irgacure@ OXE 02 from BASF SE) and mixtures thereof. Particular preference is given to 2-hydroxy-2-methyl-1-phenyl-1-propanone and 2,4,6-trimethylbenzoyldiphenylphosphine oxide and mixtures thereof.

Typical UV absorbers are benzotriazoles, cyanoacrylates, benzophenones, phenyltriazines, hydroxyphenyltrazines or oxalanilides.

Furthermore, light stabilizers such as phenols or HALS amines may also be present.

Substrate Layer D

The substrate layer D is preferably a thermoplastic substrate layer/substrate film. Materials or material composites of the thermopolastic substrate layer/substrate film D are based on polycarbonate (PC), polyethylene terephthalate (PET), amorphous polyesters, polybutylene terephthalate, polyethylene, polypropylene, cellulose acetate, cellulose hydrate, cellulose nitrate, polystyrene, hydrogenated polystyrene, polyepoxides, polysulfone (Ultrason@ from BASF or Udel® from Solvay), thermoplastic polyurethane (TPU), cellulose triacetate (CTA), polyamide (PA), polymethylmethacrylate (PMMA), polyvinyl chloride, polyvinyl acetate, polyvinylbutyral or polydicyclopentadiene or mixtures thereof, cycloolefin polymers and cycloolefin copolymers (COC; for example Topas® from Ticona; Zenoex@ from Nippon Zeon or Apel® from Japan Synthetic Rubber). They are particularly preferably based on PC, PET, PA, PMMA and CTA. In another preferred embodiment they are based on polycarbonate, polyethylene terephthalate, cellulose triacetate, polyamide, mixtures or material composites thereof. Material composites may be film laminates or coextrudates.

Preferred material composites are duplex and triplex films constructed according to one of the schemes A/B, A/B/A or A/B/C. Particularly preferred are PC/PMMA, PC/PA, PC/PET, PET/PC/PET and PC/TPU. It is preferable when substrate film D is transparent in the spectral region of 400-800 nm.

In a preferred embodiment the substrate layer D is a thermoplastic transparent plastics layer. In another preferred embodiment the substrate layer D is a thermoplastic transparent amorphous plastics layer. In another preferred embodiment the substrate layer D is a thermoplastic transparent low-birefringence plastics layer. In a further preferred embodiment the substrate layer D is an amorphous thermoplastic transparent low-birefringence plastics layer.

In a preferred embodiment the substrate layer D has a layer thickness of 5 μm to 500 μm, preferably 20 μm to 150 μm.

In a further preferred embodiment the substrate layer D consists of polycarbonate, copolycarbonate, polyethylene terephthalate, cellulose triacetate, polyamide, mixtures or material composites thereof. In another preferred embodiment the substrate layer D consists of polycarbonate, copolycarbonate, cellulose triacetate, polyethylene terephthalate, mixtures or material composites thereof.

In a preferred embodiment the film D comprises polycarbonate or copolycarbonate. Suitable polycarbonates for the production of the polycarbonate films according to the invention include all known polycarbonates. These are homopolycarbonates, copolycarbonates and thermoplastic polyester carbonates. A suitable polycarbonates preferably have an average molecular weight M_{w} of 18 000 to 40 000, more preferably of 26 000 to 36 000 and especially preferably of 28 000 to 35 000, determined by measurement of relative solution viscosity in dichloromethane or by gel permeation chromatography and polycarbonate gauging.

The polycarbonates are preferably produced by the interfacial process or the melt transesterification process which are extensively described in the literature. With regard to the interfacial process reference is made for example to H. Schnell, Chemistry and Physics of Polycarbonates, Polymer Reviews, Vol. 9, Interscience Publishers, New York 1964 p. 33 et seq., to Polymer Reviews, Vol. 10, “Condensation Polymers by Interfacial and Solution Methods”, Paul W. Morgan, Interscience Publishers, New York 1965, Chapt. VIII, p. 325, to Dres. U. Grigo, K. Kircher und P. R-Müller “Polycarbonate” in Becker/Braun, Kunststoff-Handbuch, Volume 3/1, Polycarbonate, Polyacetale, Polyester, Celluloscester, Carl Hanser Verlag Munich, Vienna 1992, p 118-145 and also to EP-A 0 517 044. The melt transesterification process is described, for example, in the Encyclopedia of Polymer Science, vol. 10 (1969), Chemistry and Physics of Polycarbonates, Polymer Reviews, H. Schnell, vol. 9, John Wiley and Sons, Inc. (1964), and in patent specifications DE-B 10 31 512 and U.S. Pat. No. 6,228,973.

The polycarbonates may be obtained from reactions of bisphenol compounds with carbonic acid compounds, in particular phosgene, or in the melt transesterification process of diphenyl carbonate/dimethyl carbonate. Particular preference is given here to homopolycarbonates based on bisphenol A and copolycarbonates based on the monomers bisphenol A and 1,1-bis(4-hydroxyphenyl)-3,3,5-trimethylcyclohexane. Further bisphenol compounds employable for polycarbonate synthesis are disclosed inter alia in WO-A 2008037364, EP-A 1 582 549, WO-A 2002026862, WO-A 2005113639.

The polycarbonates may be linear or branched. It is also possible to use mixtures of branched and unbranched polycarbonates.

Suitable branching agents for polycarbonates are known from the literature and are described, for example, in patent specifications U.S. Pat. No. 4,185,009, DE-A 25 00 092, DE-A 42 40 313, DE-A 19 943 642, U.S. Pat. No. 5,367,044 and in literature cited therein. Furthermore, the polycarbonates used may also be intrinsically branched, in which case no branching agent is added in the course of polycarbonate preparation. An example of intrinsic branching is given by so-called Fries structures, such as are disclosed for melt polycarbonates in EP-A 1 506 249.

In addition, it is possible to use chain terminators in the polycarbonate preparation. The chain terminators used are preferably phenols such as phenol, alkylphenols such as cresol and 4-tert-butylphenol, chlorophenol, bromophenol, cumylphenol or mixtures thereof.

The plastics composition(s) of the film may additionally contain additives, for example UV absorbers, IR absorbers and other customary processing aids, in particular demolding agents and flow promoters and also customary stabilizers, in particular heat stabilizers and antistats, pigments, colorants and optical brighteners. In every layer, different additives or concentrations of additives may be present.

In a further preferred embodiment the substrate layer D is a highly transparent, amorphous and mechanically stable film substrate made of cellulose triacetate (CTA oder TAC), particularly such as for example TAC having a layer thickness <200 μm, more preferably <100 μm and >20 μm, yet more preferably <65 μm and >20 μm. Examples thereof are Tacphan® 915 GL (50 μm) from LOFO High Tech Film GmbH, Well am Rhein, Germany and TAC-Film ZRD60SL 60 μm from FujiFilm Europe GmbH, Düsseldorf, Germany.

In a further preferred embodiment of the substrate layer D is a mechanically stable thermoplastic polymer substrate made of polyester, particularly such as for example polyethylene terephthalate (PET) having a layer thickness of <200 μm, preferably <100 μm and >20 μm, yet more preferably <45 μm and >20 μm, whose adhesion properties have been reduced by surface modification.

Various techniques therefor are contemplated. Thus, inorganic gliding additives may be added, for example kaolin, clay, fuller's earth, calcium carbonate, silicon dioxide, aluminium oxide, titanium oxide, calcium phosphate, and are added in amounts of up to 3%.

To improve the optical properties of such films, trilayer coextrudate films where only the outer layers contain such inorganic gliding additives (e.g. Hostaphan RNK) are also used.

The invention likewise provides for the use of the layer constructions according to the invention and of the kit of parts according to the invention for protection of a photopolymer B′ containing a volume hologram, preferably wherein the photopolymer B′ comprises three-dimensionally crosslinked matrix polymers, particularly preferably a three-dimensionally crosslinked polyurethane matrix.

The invention also provides for the use of the layer constructions according to the invention and of the kit of parts according to the invention for the process according to the invention.

In one embodiment the sealed holographic medium according to the invention contains a hologram-containing photopolymer layer having a layer thickness of 0.3 μm to 500 μm, preferably of 0.5 μm to 200 μm and particularly preferably of 1 μm to 100 μm.

In particular the hologram may be a reflection, transmission, in-line, off-axis, full-aperture transfer, white light transmission, Denisyuk, off-axis reflection or edge-lit hologram, or else a holographic stereogram, and preferably a reflection, transmission or edge-lit hologram. Preference is given to reflection holograms, Denisyuk holograms, transmission holograms.

In the photopolymer layer one or more holograms may be/may have been photoinscribed at the same location or next to one another. If photoinscribing is performed at the same location different image contents may be photoinscribed. It is likewise possible to photoinscribe different aspects of an object with slightly varying reconstruction angles to form stereograms. It is likewise possible to photoinscribe hidden holograms and microtexts. It is likewise possible in the case of transmission holograms to photoinscribe several light guiding functions and/or light guiding functions for different spectral ranges.

Possible optical functions of the holograms correspond to the optical functions of optical elements such as lenses, mirrors, deflecting mirrors, filters, diffusers, directed diffusion elements, diffraction elements, light guides, waveguides, projection screens and/or masks. In addition, a plurality of such optical functions can be combined in such a hologram, for example such that the light is deflected in a different direction according to the incidence of light. For example, it is possible with such setups to build autostereoscopic or holographic electronic displays which allow a stereoscopic visual impression to be experienced without further aids, for example polarizer or shutter glasses, for use in automobile head-up displays or head-mounted displays.

These optical elements frequently have a specific frequency selectivity according to how the holograms have been exposed and the dimensions of the hologram. This is important in particular when monochromatic light sources such as LEDs or laser light are used. For instance, one hologram is required per complementary colour (RGB), in order to deflect light in a frequency-selective manner and at the same time to enable full-colour displays. Therefore in particular display constructions a plurality of holograms are to be irradiated inside one another in the medium.

In addition the sealed holographic media according to the invention may also be used to produce holographic images or representations, for example for personal portraits, biometric representations in security documents, or generally of images or image structures for advertising, security labels, brand protection, branding, labels, design elements, decorations, illustrations, collectable cards, images and the like, and also images which can represent digital data, including in combination with the products detailed above. Holographic images may have the impression of a three-dimensional image, or else can represent image sequences, short films or a number of different objects, according to the angle from which and the light source with which (including moving light sources) etc. they are illuminated. Because of this variety of possible designs, holograms, especially volume holograms, constitute an attractive technical solution for the abovementioned application. It is also possible to use such holograms for storage of digital data, using a wide variety of different exposure methods (shift, spatial or angular multiplexing).

The invention likewise provides an optical display comprising an inventive sealed holographic medium.

Examples of such optical displays are imaging displays based on liquid crystals, organic light-emitting diodes (OLEDs), LED display panels, microelectromechanical systems (MEMS) based on diffractive light selection, electrowetting displays (E-ink) and plasma display screens. Optical displays of this kind may be autostereoscopic and/or holographic displays, transmittive and reflective projection screens, displays with switchable restricted emission characteristics for privacy filters and bidirectional multiuser screens, virtual displays, head-up displays, head-mounted displays, illumination symbols, warning lamps, signal lamps, floodlights/headlights and display panels.

The invention likewise provides autostereoscopic and/or holographic displays, projection screens, displays with switchable restricted emission characteristics for privacy filters and bidirectional multiuser screens, virtual displays, head-up displays, head-mounted displays, illumination symbols, warning lamps, signal lamps, floodlights/headlights and display panels, comprising an inventive holographic medium.

The invention still further provides a security document and a holographically optical element comprising an inventive sealed holographic medium.

In addition, the invention also provides for the use of an inventive holographic medium for production of chip cards, identity documents, 3D images, product protection labels, labels, banknotes or holographically optical elements, especially for visual displays.

The invention will now be more particularly elucidated by means of examples.

Methods of Measurement:
Solids content—The reported solids contents were determined according to DIN EN ISO 3251.

Chemicals:

In each case, the CAS number, if known, is reported in square brackets.

Raw Materials for Photopolymer Layer B

| | |
|---|---|
| Fomrez ® | Urethanization catalyst, commercial product of |
| UL 28 | Momentive Performance Chemicals, Wilton, CT, USA. |
| Borchi ® | Urethanization catalyst, [85203-81-2] commercial |
| Kat 22 | product of OMG Borchers GmbH, Langenfeld, Germany. |
| BYK-310 | silicone-containing surface additive, product of |
| | BYK-Chemie GmbH, Wesel, Germany. |
| Desmodur ® | Product of Covestro AG, Leverkusen, DE, hexane |
| N 3900 | diisocyanate-based polyisocyanate, proportion of |
| | iminooxadiazinedione of at least 30%, NCO |
| | content: 23.5%. |
| CGI-909 | tetrabutylammonium tris(3-chloro-4- |
| | methylphenyl)(hexyl)borate [1147315-11-4], |
| | product of BASF SE |

Dye 1 (3,7-bis(diethylamino)phenoxazin-5-ium bis(2-ethylhexyl)sulfosuccinate) was produced as described in WO 2012062655.

Polyol 1 was produced as described in WO2015091427.

Urethane acrylate 1 simultaneously also MAc 1, (phosphorothioyltris(oxybenzene-4,1-diylcarbamoyloxyethane-2,1-diyl) trisacrylate, [1072454-85-3]) was produced as described in WO2015091427.

Urethane acrylate 2, (2-({[3-(methylsulfanyl)phenyl]carbamoyl}oxy)ethyl prop-2-enoate, [1207339-61-4]) was produced as described in WO2015091427.

Additive 1, bis(2,2,3,3,4,4,5,5,6,6,7,7-dodecafluoroheptyl)-(2,2,4-trimethylhexane-1,6-diyl)biscarbamate [1799437-41-4] was produced as described in WO2015091427.

Raw Materials for Layer C Physically Drying Resins (Optional)

| | |
|---|---|
| Desmocoll | A linear thermoplastic flexible |
| 400/3 - | polyurethane from Covestro Deutschland |
| resin 1 | AG, Leverkusen, Germany. |
| Desmocoll | A linear thermoplastic flexible |
| 530/3 - | polyurethane from Covestro Deutschland |
| resin 2 | AG, Leverkusen, Germany. |
| Desmocoll | A linear thermoplastic flexible |
| 540/5 - | polyurethane from Covestro Deutschland |
| resin 3 | AG, Leverkusen, Germany. |
| Degacryl | A linear thermoplastic amorphous |
| M547 - | polymethyl methacrylate having an Mw of |
| resin 4 | 500 000 from Evonik Industries, Marl, |
| | Germany |

Multifunctional Acrylates

Abbreviation MAc=Multifunctional Acrylate

| | |
|---|---|
| MAc 1 | Phosphorothioyltris(oxybenzene-4,1- |
| | diylcarbamoyloxyethane-2,1-diyl) |
| | trisacrylate, [1072454-85-3]) was |
| | produced as described in WO2015091427. |
| Miramer | [94108-97-1] Ditrimethylolpropane |
| M410 - MAc 2 | tetraacrylate from Miwon Specialty |
| | Chemical Co., Ltd., Gyeonggi-do, Korea. |

Photoinitiators

| | |
|---|---|
| Esacure One - | [163702-01-0] Oligo[2-hydroxy-2-methyl- |
| Initiator 1 | 1-((4-(1-methylvinyl)phenyl)propanone] |
| | from Lamberts S.p.A., Albizzate, Italy· |
| Irgacure 4265 - | A mixture of Irgacure ® TPO (50% by weight) |
| Initiator 2 | and Irgacure ® 1173 (50% by weight) from |
| | BASF, SE, Ludwigshafen, Germany. |

Additives
BYK 333—Flow control agent Silicone-containing surface additive from BYK Chemie GmbH, Wesel, Germany

Solvent

| | |
|---|---|
| Butyl | Butyl acetate from Brenntag GmbH, |
| acetate (BA) | Mülheim an der Ruhr, Germany. |
| Ethyl | Ethyl acetate from Brenntag GmbH, |
| acetate (EA) | Mülheim an der Ruhr, Germany. |
| 2-Butanone | 2-Butanone from Brenntag GmbH, |
| | Mülheim an der Ruhr, Germany. |
| Methoxypropanol | 1-Methoxy-2-propanol from Brenntag |
| (MP-ol) | GmbH, Mülheim an der Ruhr Germany. |

Substrate Films of Layer D

| | |
|---|---|
| Kaneka PC - D1 | Polycarbonate film from Kaneka Corp., |
| | Tokyo, Japan. Film thickness 66 μm. |
| Hostaphan | Polyethylene terephthalate film from |
| RNK - D2 | Mitsubishi Polyester Film GmbH, Wiesbaden, |
| | Germany, film thickness 36 μm. |
| ZRD60SL - D3 | Cellulose triacetate film Z-TAC ″ZRD60SL |
| | from FujiFilm Europe GmbH, Düsseldorf, |
| | Germany, film thickness 60 μm. |

Production of Holographic Media (Photopolymer Film) 7.90 g of the above-described polyol component were melted and mixed with 7.65 g of the respective urethane acrylate 2, 2.57 g of the above-described urethane acrylate 1, 5.10 g of the above-described fluorinated urethane, 0.91 g of CGI 909, 0.232 g of dye 1, 0.230 g of BYK 310, 0.128 g of Fomrez UL 28 and 3.789 g of ethyl acetate to obtain a clear solution. This was followed by addition of 1.50 g Desmodur® N 3900 and renewed mixing.

This solution was then applied to a PET film of 36 μm in thickness in a roll-to-roll coating plant where by means of a knife coater the product was applied in a wet layer thickness of 19 m. With a drying temperature of 85° C. and a drying time of 5 minutes, the coated film was dried and then protected with a polyethylene film of 40 μm in thickness. Subsequently, this film was light-tightly packaged.

Production of the UV-Curable Layer C on Substrate Layer D

The formulations reported in table I were produced when the physically drying resins, dissolved at 100° C. in the reported organic solvent and cooled to room temperature, were mixed with the reactive diluent. The photoinitiators and also flow control agents were then added in darkness.

TABLE 1
Coating compositions* for production of
the layers C of the adhesive film C-D

| | | | | |
|---|---|---|---|---|
| | | Ratio of | Content (% by | Viscosity |
| | | resin and | weight) and | of solution |
| | | MAc in | solvent of the | at 23° C. |
| Resin | MAc | lacquer | coating solution | [mPas] |

Inventive examples

| | | | | | |
|---|---|---|---|---|---|
| C-01 | — | MAc 1 | 0/100 | 45% in 1-methoxy- | 26 |
| | | | | 2-propanol | |
| C-02 | 1 | MAc 1 | 40/60 | 26% in butyl | 1120 |
| | | | | acetate | |
| C-03 | 2 | MAc 1 | 30/70 | 26% in 2-butanone/ | 690 |
| | | | | ethyl acetate | |
| | | | | (30:70% by weight) | |
| C-04 | 3 | MAc 1 | 30/70 | 15% in 2-butanone | 650 |

Noninventive examples

| | | | | | |
|---|---|---|---|---|---|
| C-N01 | 1 | MAc 2 | 50/50 | 25% in butyl | 2220 |
| | | | | acetate | |
| C-N02 | 4 | MAc 1 | 20/80 | 28% in 1-methoxy- | 111 |
| | | | | 2-propanol | |

*All coating compositions contain initiator 1 (3.0% by weight based on solids content of lacquer) and initiator 2 (1.5% by weight based on solids content of lacquer);

The coating compositions C-01 to C-04 and likewise the noninventive coating compositions C-N01 and C-N02 were applied atop the film substrates D1, D2 and D3 in a roll-to-roll coating plant by means of a knife coater. At a drying temperature of 85° C. and a drying time of 5 minutes the coated film was dried and subsequently protected with a polyethylene film of 40 μm in thickness. The coating thickness was generally 15-16 μm. Subsequently, this film was light-tightly packaged.

Production of Test Holograms in the Film Composite A-B

The test holograms were prepared as follows: the photopolymer films with the layer construction A-B were in darkness cut to the desired size and using a rubber roller laminated onto a glass sheet having dimensions of 50 mm×70 mm (3 mm thick). The test holograms were produced using a test apparatus which produces Denisyuk reflection holograms using green (532 nm) laser radiation. The test apparatus consists of a laser source, an optical beam guide system and a holder for the glass coupons. The holder for the glass coupons is mounted at an angle of 13° relative to the beam axis. The laser source generated the radiation which, widened to about 5 cm by means of a specific optical beam path, was guided to the glass coupon in optical contact with the mirror. The holographed object was a mirror about 2 cm×2 cm in size, and so the wavefront of the mirror was reconstructed on reconstructing the hologram. All examples were irradiated with a green 532 nm laser (Newport Corp., Irvine, Calif., USA, cat. no. EXLSR-532-50-CDRH). A shutter was used to irradiate the recording film in a defined manner for 2 seconds. This forms a film composite A-B* comprising a hologram in layer B.

Subsequently, the samples were placed onto the conveyor belt of a UV source with the B side facing the lamp and irradiated twice at a belt speed of 2.5 m/min. The UV source employed was a Fusion UV “D Bulb” No. 558434 KR 85 iron-doped Hg lamp having a total power density 80 W/cm². The parameters corresponded to a dose of 2×2.5 J/cm² (measured with an ILT 490 Light Bug). After this fixing step the film composite A-B′ is formed.

Characterization of Test Holograms

The holograms in layer B′ of the film composite A-B′ were then analysed by spectroscopy and the quality of the holograms assessed.

On account of the high diffraction efficiency of the volume hologram, the diffractive reflection of such holograms may be analysed in transmission with visible light with a spectrometer (USB 2000 instrument, Ocean Optics, Dunedin, Fla., USA, is employed) and appears in the transmission spectrum as a peak with reduced transmission T_{R}. Evaluating the transmission curve makes it possible to determine the quality of the hologram according to ISO standard 17901-1:2015(E) taking account of the following measured values; all results are summarized in table 3 in the section “spectral quality of holograms”, column “in A-B”:
T_{Red}=100−T_{peak(A-B′)} (1) Maximum depth of the transmission peak, this corresponds to the highest diffraction efficiency. Thus, T_{Red} serves as a measure for the reflective power (or visible “strength” or “quality”) of the hologram.
FWHM The width of the transmission peak is determined as “full width at half maximum” (FWHM) in nanometres (nm).
λₚₑₐₖ Spectral position of the transmission minimum of the hologram in nanometres (nm).
Δλ Difference of transmission minima in layer construction A-B′ to layer construction A-B′-C′-D as Δλ=λ_{peak(A-B′)}−λ_{peak(A-B′-C′-D)} (3)

The films having the layer structure A-B′ were then provided with the sealing layer/adhesive film C-D in the process according to the invention. The holograms were then also reanalysed for quality in the layer construction A-B′-C′-D and compared with the original values for the layer construction A-B′, see values for Δλ (tab. 3).

Production of a Film Composite Having Layer Construction A-B′-C′-D

The film composite having the layer construction A-B′-C′-D is produced by lamination of side B′ of layer composite/film A-B′ onto side C of layer composite/film C-D. This is effected by pressing together the two films between the rubber rollers of a laminator. The temperature of the rollers was set to 30° C., 60° C. or 90° C. The produced multilayer film was cooled to room temperature. Subsequently, the samples A-B′-C-D were placed onto the conveyor belt of a UV source with the D-side facing the lamp and irradiated twice at a belt speed of 2.5 m/min. The UV source employed was a Fusion UV “D Bulb” No. 558434 KR 85 iron-doped Hg lamp having a total power density of 80 W/cm². The parameters corresponded to a dose of 2×2.5 J/cm² (measured with an ILT 490 Light Bug). After this hardening step the film composite A-B′-C′-D is formed.

Table 2 shows that all inventive samples are readily producible by laminating and UV-curing steps. The noninventive sample C-N02-D2 cannot be produced. Noninventively constructed layer C-N02 has the result that the lamination does not succeed.

TABLE 2
Adhesive bonding strengths in film composite A-B′-C′-D

| | Coating composition C | | | | | Adhesion of | Adhesion of film D |
|---|---|---|---|---|---|---|---|
| | | Component | | | T_{Lam} | C′ to B′ in | in A-B′-C′-D |
| Sample | Designation | resin | MAc | Film D | [° C.] | the process | film composite |

Inventive examples

| | | | | | | | |
|---|---|---|---|---|---|---|---|
| C-01-D1 | C01 | | MAc 1 | D1 | 30 | + | 1-2 |
| C-01-D2-1 | C01 | — | MAc 1 | D2 | 30 | + | 1 |
| C-01-D2-2 | C01 | — | MAc 1 | D2 | 60 | + | 1 |
| C-01-D3 | C01 | — | MAc 1 | D3 | 60 | + | 0 |
| C-02-D1-1 | C02 | resin 1 | MAc 1 | D1 | 30 | + | 2-3 |
| C-02-D1-2 | C02 | resin 1 | MAc 1 | D1 | 60 | + | 2-3 |
| C-02-D1-3 | C02 | resin 1 | MAc 1 | D1 | 90 | | 2-3 |
| C-03-D1-1 | C03 | resin 2 | MAc 1 | D1 | 30 | + | 1-2 |
| C-03-D1-2 | C03 | resin 2 | MAc 1 | D1 | 60 | + | 1-2 |
| C-03-D1-3 | C03 | resin 2 | MAc 1 | D1 | 90 | + | 1-2 |
| C-04-D1-1 | C04 | resin 3 | MAc 1 | D1 | 30 | + | 2 |
| C-04-D1-1 | C04 | resin 3 | MAc 1 | D1 | 60 | + | 2 |

Noninventive examples

| | | | | | | | |
|---|---|---|---|---|---|---|---|
| C-N01-D2 | C-N01 | resin 1 | MAc 2 | D2 | 30 | + | 4 |
| C-N02-D2 | C-N02 | resin 4 | MAc 1 | D2 | 30 | − | # |

# film composite A-B′-C′-D not accomplished.

Investigation of Adhesion in Film Composite A-B′-C′-D

The cohesion of all layers of the film composite was tested and evaluated by the following method. It was attempted to pull the films of the composite apart by hand. The results are quantified in the following grades from full adhesion (parameter: 0) up to almost no adhesion (parameter: 5):

0—adhesion strong enough that nothing may be nondestructively peeled off;

1—strong adhesion, substrate D can be peeled off only with severe use of force;

2—medium to strong adhesion, can be peeled off with lesser use of force than for 1;

3—medium adhesion, can be peeled off similarly to standard office adhesive tape;

4—poor adhesion, only held by adhesive forces;

5—no adhesion, falls off.

The values reported in table 2 show that the inventive examples form a very good (parameter 0) to good (parameter 2-3) adhesive composite.

The noninventive example C-NO 1-D2 is only very weakly cohesive.

Characterization of Test Holograms

The holograms in layer B′ of the film composite A-B′ which are initially measured before application of any protective layers are now analysed by spectroscopy for possible loss of quality in the layer composite A-B′-C′-D.

The values of T_{Red}=100−T_{peak(A-B′-C′-D)} (1) for the inventive samples differ only minimally from the corresponding values for A-B′ and only in individual cases reach a deviation of almost 9%. A large loss in hologram quality of 19% is recorded only for the noninventive example C-N01-D2.

The same tendency also affects the spectral position of the transmission peak λₚₑₐₖ. As is shown by the difference Δλ=λ_{peak(A-B′-C′-D)}−λ_{peak(A-B′)} (3) the maximum deviation of λₚₑₐₖ is <8 nm. The noninventive example C-N01-D2 shows substantially higher values. In addition the spectral peak in this case is not uniform which indicates damage to the hologram.

TABLE 3
Quality of holograms inscribed in the A-B film composite then fixed using UV-VIS,
then film composite C-D laminated onto resulting film composite A-B′, then film composite
A-B′-C-D irradiated with 5 J/cm² of UV to form film composite A-B′-C′-D.

| | Coating composition | | | | | Spectral quality of holograms | | | | | | |
|---|---|---|---|---|---|---|---|---|---|---|---|---|
| | C | | | | | in A-B′ | | | in A-B′-C′-D | | | |
| | | Component | | | T_{Lam} | T_{Red} | FWHM | λₚₑₐₖ | T_{Red} | FWHM | λₚₑₐₖ | Δλ |
| Sample | Designation | Resin | MAc | Film D | [° C.] | [%] | [nm] | [nm] | [%] | [nm] | [nm] | [nm] |

Inventive examples

| | | | | | | | | | | | | |
|---|---|---|---|---|---|---|---|---|---|---|---|---|
| C-01-D1 | C01 | — | MAc 1 | D1 | 30 | 89.9 | 25.3 | 528 | 91.9 | 24.9 | 533 | 6 |
| C-01-D2-1 | C01 | — | MAc 1 | D2 | 30 | 90.5 | 24.5 | 530 | 92.1 | 24.1 | 534 | 4 |
| C-01-D2-2 | C01 | — | MAc 1 | D2 | 60 | 93.4 | 22 5 | 528 | 84.4 | 25.0 | 535 | 7 |
| C-01-D3 | C01 | — | MAc 1 | D3 | 60 | 92.9 | 20.4 | 529 | 91.3 | 27.4 | 535 | 6 |
| C-02-D1-1 | C02 | 1 | MAc 1 | D1 | 30 | 92.9 | 21.9 | 530 | 90.1 | 25.3 | 526 | −4 |
| C-02-D1-2 | C02 | 1 | MAc 1 | D1 | 60 | 93.1 | 21.5 | 529 | 92.6 | 23.4 | 529 | 0 |
| C-02-D1-3 | C02 | 1 | MAc 1 | D1 | 90 | 92.4 | 22.0 | 530 | 89.8 | 21.1 | 534 | 4 |
| C-03-D1-1 | C03 | 2 | MAc 1 | D1 | 30 | 92.9 | 22.0 | 529 | 91.6 | 22.5 | 529 | 0 |
| C-03-D1-2 | C03 | 2 | MAc 1 | D1 | 60 | 93.0 | 22.0 | 529 | 92.1 | 23.7 | 533 | 3.9 |
| C-03-D1-3 | C03 | 2 | MAc 1 | D1 | 90 | 91.7 | 22.3 | 529 | 91.4 | 22.2 | 537 | 7.9 |
| C-04-D1-1 | C04 | 3 | MAc 1 | D1 | 30 | 95.4 | 10.1 | 531 | 91.9 | 11.1 | 531 | 0 |
| C-04-D1-1 | C04 | 3 | MAc 1 | D1 | 60 | 95.4 | 10.1 | 531 | 90.4 | 10.8 | 531 | 0 |

Noninventive examples

| | | | | | | | | | | | | |
|---|---|---|---|---|---|---|---|---|---|---|---|---|
| C-N01-D2 | C-N01 | 1 | MAc 2 | D2 | 30 | 93.9 | 23.3 | 527 | 74.9^{§} | 30.6⁻ | 540 | 13 |
| C-N02-D2 | C-N02 | 4 | MAc 1 | D2 | 30 | 92.5 | 20.7 | 529 | * | — | — | — |

*film composite A-B′-C′-D not accomplished;
^{§}no solid film composite, D adheres only weakly;
⁻spectral peak not uniform, several additional peaks;

1.-16. (canceled)

17. A sealed holographic medium comprising a layer construction B′-C′-D, wherein
B′ is a photopolymer layer containing a hologram, obtained from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances,
wherein the photopolymer layer B′ is at least partly joined to the layer C′,
C′ is an at least partly actinic-radiation-cured areal layer obtainable from a curable layer C comprising
I) at least one multifunctional acrylate,
II) at least one photoinitiator and
III) optionally assistant and added substances and
D is an areal substrate layer at least partly joined to layer C′,
wherein all multifunctional acrylates of the curable layer C are identical to at least one writing monomer of the unirradiated photopolymer layer B.

18. The sealed holographic medium according to claim 17, wherein the photopolymer layer B′ is at least partly joined on one side to an areal substrate layer A, wherein the layers are arranged directly atop one another in the sequence A-B′-C′-D, wherein the substrate layer A is a transparent thermoplastic substrate layer or another carrier.

19. The sealed holographic medium according to claim 17, wherein the back of the photopolymer layer B′ is at least partly joined to a second at least partly actinic-radiation-cured layer C′, wherein the second layer C′ is on the other side at least partly joined to an areal substrate layer D, wherein the layers are arranged directly atop one another in the sequence D-C′-B′-C′-D.

20. A layer construction comprising a curable layer C and an areal substrate layer D at least partly joined to the layer C, wherein the curable layer C comprises
I) at least one multifunctional acrylate,
II) at least one photoinitiator and
III) optionally assistant and added substances.

21. A kit of parts containing at least one areal photopolymer B′ containing a hologram, and a sealing layer comprising a curable layer C and an areal substrate layer D at least partly joined to the curable layer C, wherein the curable layer C comprises
I) at least one multifunctional acrylate,
II) at least one photoinitiator and
III) optionally assistant and added substances,
wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and
wherein all multifunctional acrylates of the curable layer C are identical to at least one writing monomer of the unirradiated photopolymer layer B.

22. A process for producing the sealed holographic medium according to claim 17, wherein a sealing layer comprising a curable layer C and an areal substrate layer D at least partly joined to the curable layer C is applied atop a photopolymer B′ containing a hologram to afford a layer composite B′-C-D and subsequently the curable layer C is at least partly cured with actinic radiation to afford a layer construction B′-C′-D, wherein C′ is the at least partly cured layer C,
wherein the curable layer C comprises
I) at least one multifunctional acrylate,
II) at least one photoinitiator and
III) optionally assistant and added substances,
wherein the photopolymer layer B′ containing a hologram is obtainable from an unirradiated photopolymer B comprising
I) matrix polymers,
II) writing monomers,
III) photoinitiators,
IV) optionally at least one non-photopolymerizable component,
V) optionally catalysts, free-radical stabilizers, solvents, additives and other assistant and/or added substances, and
wherein all multifunctional acrylates of the curable layer C are identical to at least one writing monomer of the unirradiated photopolymer layer B.

23. The process according to claim 22, wherein in a first step a layer composite A-B′ or D-C′-B′ is provided, wherein A is a substrate layer, in a second step the curable layer C is applied atop the substrate layer D to afford a layer composite C-D, in a third step the layer composite C-D is areally joined to the layer composite A-B′ or to the layer composite D-C′-B′, to afford a layer composite A-B′-C-D or a layer composite D-C′-B′-C-D and in a fourth step the layer composite A-B′-C-D or the layer composite D-C′-B′-C-D is subjected to actinic radiation to afford a layer composite A-B′-C′-D or a layer composite D-C′-B′-C′-D.

24. The sealed holographic medium according to claim 17, wherein the curable layer C further comprises at least one thermoplastic mainly linear semicrystalline polyurethane resin.

25. The sealed holographic medium according to claim 17, wherein the multifunctional acrylate of the curable layer C is selected from the group consisting of phosphorothioyltris(oxybenzene-4,1-diylcarbamoyloxyethane-2,1-diyl)trisacrylate, phosphoroxytris(oxybenzene-4,1-diylcarbamoyloxyethan-2,1-diyl)trisacrylate, 2-[[4-[bis[4-(2-prop-2-enoyloxyethoxycarbonylamino)phenyl]methyl]phenyl]carbamoyloxy]ethyl prop-2-enoate.

26. The sealed holographic medium according to claim 17, wherein the substrate layer D is a thermoplastic transparent plastics layer.

27. The sealed holographic medium according to claim 17, wherein the substrate layer D consists of polycarbonate, copolycarbonate, polyethylene terephthalate, cellulose triacetate, polyamide, mixtures or material composites thereof.

28. The sealed holographic medium according to claim 17, wherein the substrate layer D has a layer thickness of 5 μm to 500 μm.

29. A method comprising utilizing the kit of parts according to claim 21 to produce a sealed holographic medium.

30. A method comprising utilizing the layer construction according to claim 20 for protection of a photopolymer B′ containing a volume hologram, wherein the photopolymer B′ comprises three-dimensionally crosslinked matrix polymers.

31. An optical display comprising the sealed holographic medium according to claim 17, wherein the optical display is selected from the group consisting of autostereoscopic and/or holographic displays, projection screens, displays with switchable restricted emission characteristics for privacy filters and bidirectional multiuser screens, virtual displays, head-up displays, head-mounted displays, illumination symbols, warning lamps, signal lamps, floodlights/headlights and display panels.

32. A security document comprising the sealed holographic medium according to claim 17.
